(19) United States
(12) Patent Application Publication
(10) Pub. No.: US 2026/0196125 A1
(43) Pub. Date: Jul. 9, 2026

(54) INFORMATION PROCESSING APPARATUS, SAFETY CONFIRMATION SYSTEM, INFORMATION PROCESSING METHOD, AND INFORMATION PROCESSING PROGRAM

(71) Applicant: NTT, Inc., Tokyo (JP)

(72) Inventors: Shingo HORIUCHI, Tokyo (JP); Masataka SATO, Tokyo (JP)

(73) Assignee: NTT, Inc., Tokyo (JP)

(21) Appl. No.: 19/130,752

(22) PCT Filed: Dec. 16, 2022
(86) PCT No.: PCT/JP2022/046508

§ 371 Date: May 16, 2025

(51) Int. Cl. G08B 26/00

(52) U.S. Cl. CPC G08B 26/007; G08B 26/001

(57) ABSTRACT

An information processing device according to an aspect of the present invention includes a position detection unit, a notification unit, and a safety answer unit. The position detection unit detects a current position of the information processing device. When receiving a safety confirmation request including a disaster occurrence position via a communication network, the notification unit notifies that the safety confirmation request has been received. When the disaster occurrence position included in the safety confirmation request is far from the current position by a threshold distance or more, the safety answer unit returns a specified safety status.

### TECHNICAL FIELD

An aspect of the present invention relates to an information processing device, a safety confirmation system, an information processing method, and an information processing program.

### BACKGROUND ART

In recent years, earthquakes exceeding a seismic intensity of upper 6 frequently occur in Japan and other countries, and occasions for safety registration are increasing. Therefore, various safety confirmation systems capable of transmitting registration requests through various channels to all users registered in the system and confirming answer statuses from the users have been proposed and actually operated (see, for example, Non Patent Literatures 1 to 4).

### CITATION LIST

### Non Patent Literature

Non Patent Literature 1: Ryosuke Aoki, Akihiro Miyata, et al., “Toiawase to douji ni jikoanpitouroku wo okonau anpi kakunin system (in Japanese) (Safety confirmation system that performs self-safety registration simultaneously with inquiry) “, Multimedia, Distributed, Collaborative and Mobile (DICOMO2013) Symposium, p. 1922-1929, (2013)
Non Patent Literature 2: Yuu Koyama, Teruhiro Mizumoto, et al., “Proposal of DIN-based disaster safety confirmation system cooperating with disaster database and Twitter”, Multimedia Communication and Distributed Processing Workshop 2011 Papers, pp. 89-93, 2011 Sep. 28, (2011)
Non Patent Literature 3: “L alert no gaiyou (in Japanese) (Overview of L alert)”, [Online], Internet <URL: https://www.soumu.go.jp/main content/000650512.pdf>
Non Patent Literature 4: “[Hikaku hyou] Anpi kakunin system hikaku 14 sen! nichijyouzukai dekirumonowa? (in Japanese) ([Comparison table] 14 safety confirmation systems selected for comparison! Which is daily usable?)”, [Online], [retrieved on Nov. 8, 2022], the Internet <URL: https://www.aspicjapan.org/asu/article/1224>

### SUMMARY OF INVENTION

### Technical Problem

On the other hand, the way of working remotely is becoming common, and the number of users who are in distant areas that are clearly not affected when a disaster occurs is also increasing. Therefore, even in a case where the user is far away from the disaster occurrence site and there is no safety problem, it is necessary to answer to all the safety confirmation requests issued in Japan. Furthermore, even if there is a time difference or it is in the middle of the night, the user is required to answer early.

An administrator who performs the safety confirmation needs to individually confirm the safety of the user by telephone or the like which is another means and promptly confirm the safety of all the users until they answer. Since the user who is at a position far away from the disaster occurrence site tends to answer to the safety confirmation request regarding the disaster unrelated to the user, the individual confirmation is a heavy burden for both the user and the manager.

The present invention has been made in view of the above circumstances, and an object of the present invention is to provide a technology capable of achieving both user convenience and comprehensive and prompt safety confirmation.

### Solution to Problem

In order to solve the above problem, an information processing device according to an aspect of the present invention includes a position detection unit, a notification unit, and a safety answer unit. The position detection unit detects a current position of the information processing device. When receiving a safety Confirmation request including a disaster occurrence position via a communication network, the notification unit notifies that the safety confirmation request has been received. When the disaster occurrence position included in the safety confirmation request is far from the current position by a threshold distance or more, the safety answer unit returns a specified safety status.

### Advantageous Effects of Invention

According to an aspect of the present invention, a safety status is automatically returned to a safety confirmation request in a case where a disaster occurrence position is distant from a current position by a threshold distance or more, so that it is possible to provide a technology capable of achieving both user convenience and comprehensive and prompt safety confirmation.

### BRIEF DESCRIPTION OF DRAWINGS

FIG. 1 is a diagram illustrating an example of a configuration of a safety confirmation system according to a first embodiment of the present invention.

FIG. 2 is a block diagram illustrating an example of a hardware configuration of a safety management device as a first information processing device according to the first embodiment of the present invention.

FIG. 3 is a block diagram illustrating an example of a software configuration of the safety management device.

FIG. 4 is a diagram illustrating an example of a safety information table stored in a safety information storage unit of the safety management device.

FIG. 5 is a block diagram illustrating an example of a hardware configuration of a user terminal as a second information processing device according to the first embodiment of the present invention.

FIG. 6 is a block diagram illustrating an example of a software configuration of a user terminal.

FIG. 7 is a flowchart illustrating an example of a processing procedure and processing contents of safety management processing performed by a control unit of the safety management device.

FIG. 8 is a flowchart illustrating an example of a processing procedure and processing contents of safety answer processing performed by a control unit of the user terminal.

FIG. 9 is a diagram illustrating a display example of an aggregated safety status in a safety manager terminal as a third information processing device in the safety confirmation system.

FIG. 10 is a block diagram illustrating an example of a software configuration of the safety management device as a first information processing device according to a second embodiment of the present invention.

FIG. 11 is a block diagram illustrating an example of a software configuration of a user terminal as a second information processing device according to the second embodiment of the present invention.

FIG. 12 is a flowchart illustrating an example of a processing procedure and processing contents of safety management processing performed by a control unit of the safety management device in the second embodiment.

FIG. 13 is a flowchart illustrating an example of a processing procedure and processing contents of safety answer processing performed by a control unit of the user terminal as the second information processing device according to the second embodiment of the present invention.

FIG. 14 is a block diagram illustrating an example of a software configuration of the safety management device as a first information processing device according to a third embodiment of the present invention.

FIG. 15 is a flowchart illustrating an example of a processing procedure and processing contents of safety management processing performed by a control unit of the safety management device in the third embodiment.

FIG. 16 is a flowchart illustrating an example of a processing procedure and processing contents of safety answer processing performed by a control unit of a user terminal as a second information processing device according to the third embodiment of the present invention.

### DESCRIPTION OF EMBODIMENTS

Hereinafter, embodiments according to the present invention will be described with reference to the drawings.

### First Embodiment

### Configuration Example

### (1) System

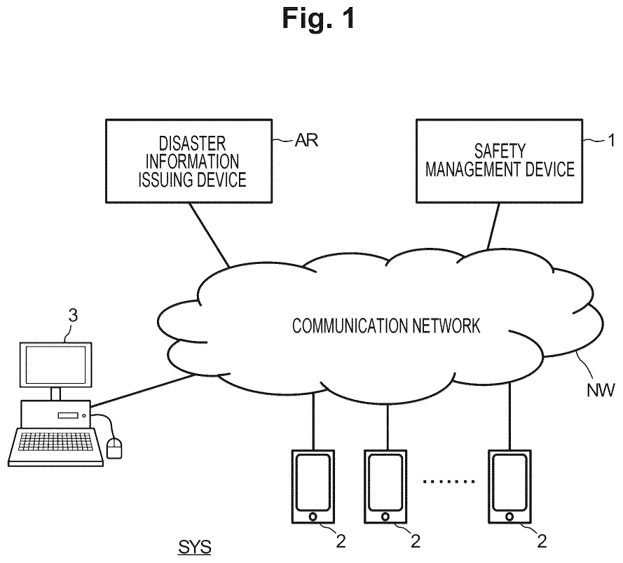

FIG. 1 is a diagram illustrating an example of a configuration of a safety confirmation system SYS according to a first embodiment of the present invention.

The safety confirmation system SYS of the first embodiment includes a safety management device 1 as a first information processing device according to the first embodiment of the present invention. The safety confirmation system SYS is configured such that the safety management device 1 can perform communication between a plurality of user terminals 2 as a second information processing device according to the first embodiment of the present invention and a safety manager terminal 3 as a third information processing device via a communication network NW. The communication network NW includes a plurality of types of networks such as an Internet Protocol (IP) network constituting the Internet, Ethernet (registered trademark) constituting a Local Area Network (LAN), and other transmission networks. As the communication network NW, any network may be used as long as information data can be transmitted. In addition, a disaster information issuing device AR that issues disaster information such as an L alert is connected to the communication network NW.

In the safety confirmation system SYS, when the safety management device 1 receives the disaster information from the disaster information issuing device AR via the communication network NW, the safety management device 1 simultaneously transmits the safety confirmation request to the plurality of user terminals 2 via the communication network NW. Then, when each user terminal 2 returns the safety status to the safety confirmation request via the communication network NW, the safety management device 1 aggregates the safety statuses and transmits the aggregated safety status to the safety manager terminal 3 via the communication network NW, and the aggregated safety status is displayed in the safety manager terminal 3.

### (2) Device

### (2-1) Safety Management Device 1

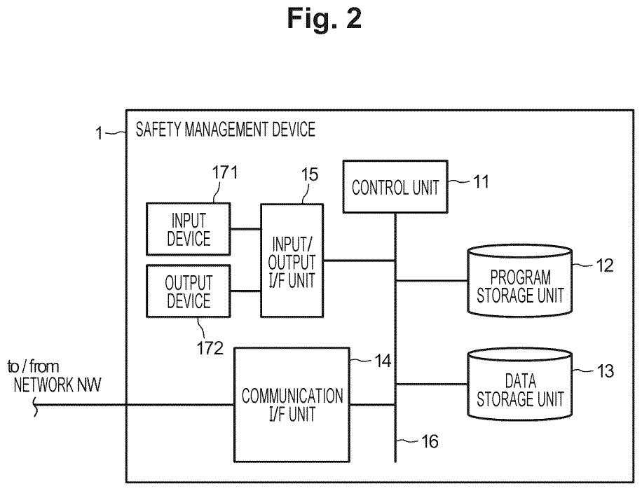

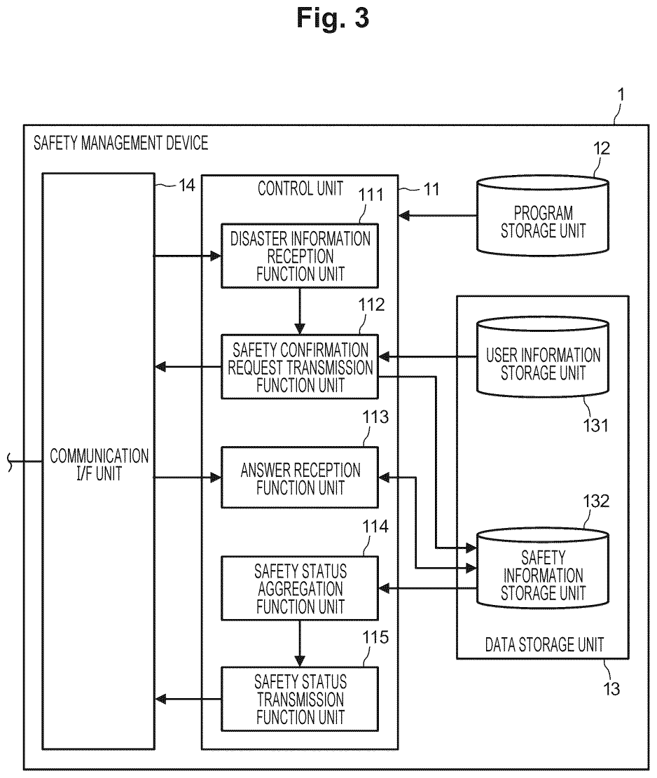

FIGS. 2 and 3 are block diagrams illustrating an example of a hardware configuration and a software configuration of the safety management device 1.

The safety management device 1 includes, for example, a server computer installed on a web or a cloud. The safety management device 1 may be an information processing device such as a personal computer.

The safety management device 1 includes a control unit 11, and a storage unit including a program storage unit 12 and a data storage unit 13, a communication interface (hereinafter, the interface is referred to as an I/F) unit 14, and an input/output I/F unit 15 are connected to the control unit 11 via a bus 16.

The control unit 11 is a hardware processor such as a central processing unit (CPU). For example, the CPU can simultaneously execute a plurality of types of information processing when a multi-core and multi-thread one is used. The control unit 11 may include a plurality of hardware processors.

An input device 171 and an output device 172 are connected to the input/output I/F unit 15. The input device 171 includes, for example, a keyboard, a mouse, and an operation button. The input device 171 is used by an operator of the safety management device 1 to input an instruction necessary for the operation of the safety management device 1. The input device 171 may include a reader device for reading information from a recording medium storing various kinds of information such as programs and data. The output device 172 includes, for example, a display, and displays various kinds of information to the operator of the safety management device 1.

The communication I/F unit 14 transmits information between the user terminal 2 and the safety manager terminal 3 using a communication protocol defined by the communication network NW under the control of the control unit 11. The input of information to the safety management device 1 and the display of information on the safety management device 1 can be performed by the communication I/F unit 14 in an information terminal which is another information processing device (not illustrated) used by the operator of the safety management device 1, via the communication network NW. Therefore, the input device 171 and the output device 172 are options, and the safety management device 1 may not have at least one of them.

The program storage unit 12 is configured, as a storage medium, for example, by a combination of a nonvolatile memory capable of writing and reading at any time, such as a hard disk drive (HDD) or a solid state drive (SSD), and a nonvolatile memory such as a read only memory (ROM), The program storage unit 12 stores an application program necessary for information processing according to the first embodiment in addition to middleware such as an operating system (OS). Hereinafter, the OS and each application program are collectively referred to as a program.

For example, the data storage unit 13 is a combination of a nonvolatile memory into and from which writing and reading can be performed at any time, such as an HDD or an SSD, and a volatile memory such as a random access memory (RAM), as a storage medium. The data storage unit 13 includes, in its storage region, a user information storage unit 131 and a safety information storage unit 132 as main storage units necessary for carrying out the first embodiment of the present invention. The user information storage unit 131 stores user information regarding users of the plurality of user terminals 2. The user information can include information such as user identification information (ID), a user name, an address, a transmission destination of the safety confirmation request, and the like. The safety information storage unit 132 stores the safety information returned from the plurality of user terminals 2.

The control unit 11 includes a disaster information reception function unit 111, a safety confirmation request transmission function unit 112, an answer reception function unit 113, a safety status aggregation function unit 114, and a safety status transmission function unit 115 as processing function units necessary for implementing the first embodiment. Each of these processing function units 111 to 115 is achieved by causing a hardware processor of the control unit 11 to execute an information processing program in the first information processing device according to the first embodiment of the present invention stored in the program storage unit 12.

In addition to being stored in the program storage unit 12 in advance, the information processing program may be downloaded from an information terminal, which is another information processing device (not illustrated) used by the operator of the safety management device 1, a program server (not illustrated), or the like when necessary, and stored in the program storage unit 12.

Furthermore, at least some processing functions of at least one of the processing function units 111 to 115 may be implemented by an integrated circuit such as an application specific integrated circuit (ASIC), a digital signal processor (DSP), a field-programmable gate array (FPGA), or a graphics processing unit (GPU) instead of being implemented by the information processing program and the hardware processor of the control unit 11.

The disaster information reception function unit 111 receives the disaster information issued by the disaster information issuing device AR via the communication I/F unit 14. The disaster information includes a disaster occurrence time, a disaster occurrence position (for example, longitude, latitude, and the like), a disaster type, a disaster scale (for example, magnitude or the like), and the like. The disaster information reception function unit 111 transmits the disaster occurrence position included in the received disaster information to the safety confirmation request transmission function unit 112.

The safety confirmation request transmission function unit 112 generates a safety confirmation request including the disaster occurrence position, and simultaneously transmits the generated safety confirmation request from the communication I/F unit 14 to the plurality of user terminals 2 via the communication network NW on the basis of the transmission destination of each user stored in the user information storage unit 131.

The answer reception function unit 113 receives the safety status transmitted from each user terminal 2 via the communication network NW from the communication I/F unit 14 and stores the safety status in the safety information storage unit 132.

The safety status aggregation function unit 114 aggregates the safety statuses from the user terminals 2 stored in the safety information storage unit 132. The safety status aggregation function unit 114 transmits the aggregated safety status to the safety status transmission function unit 115.

The safety status transmission function unit 115 transmits the aggregated safety status from the communication I/F unit 14 to the safety manager terminal 3 via the communication network NW,

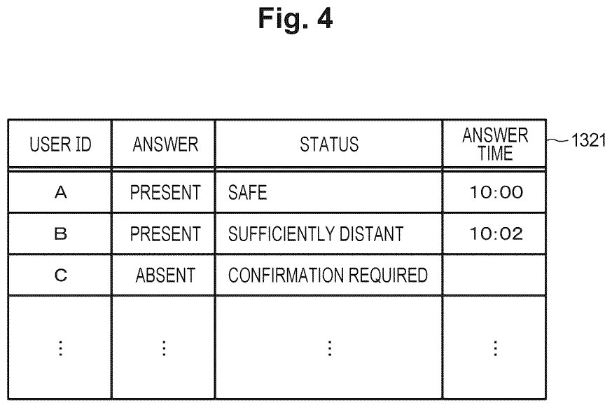

FIG. 4 is a diagram illustrating an example of a safety information table 1321 stored in the safety information storage unit 132. The answer reception function unit 113 can store the safety status from each user terminal 2 in the safety information storage unit 132, for example, in the form of the safety information table 1321. As illustrated in FIG. 4, in the safety information table 1321, information on each item of a user ID, an answer, a status, and an answer time is stored as a record for each user.

The user ID corresponds to the user information stored in the user information storage unit 131, and when simultaneously transmitting the safety confirmation request to the plurality of user terminals 2, the safety confirmation request transmission function unit 112 can store the safety information table 1321 storing the user ID of the user of the transmitted user terminal 2 in the safety information storage unit 132.

The answer indicates whether there is a reply of the safety status from the user terminal 2. When the safety information table 1321 is stored in the safety information storage unit 132, the safety confirmation request transmission function unit 112 can store “absent” as an initial value in the answer item in the record of each user. When there is a reply of the safety status from the user terminal 2, the value of the item of the reply is updated to “present” and stored by the answer reception function unit 113.

The status indicates the content of the safety status from the user terminal 2. When the safety information table 1321 is stored in the safety information storage unit 132, the safety confirmation request transmission function unit 112 can store “confirmation required” as an initial value in the item of the situation in the record of each user. When there is a reply of the safety status from the user terminal 2, the value of the item of the status is updated and stored to a value according to the status content included in the received safety information by the answer reception function unit 113.

The answer time indicates the time when the reply of the safety status from the user terminal 2 is received. When there is a reply of the safety status from the user terminal 2, the answer reception function unit 113 stores the current time clocked by a clock (not illustrated) as the value of the item of the answer time.

### (2-2) User Terminal 2

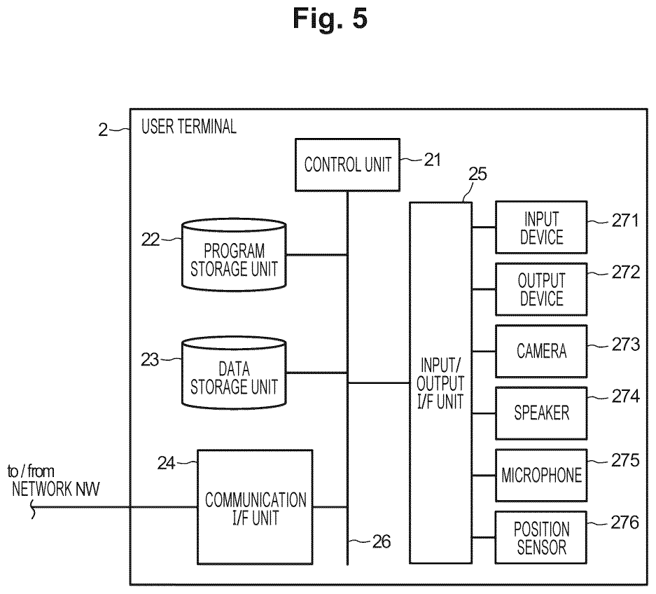

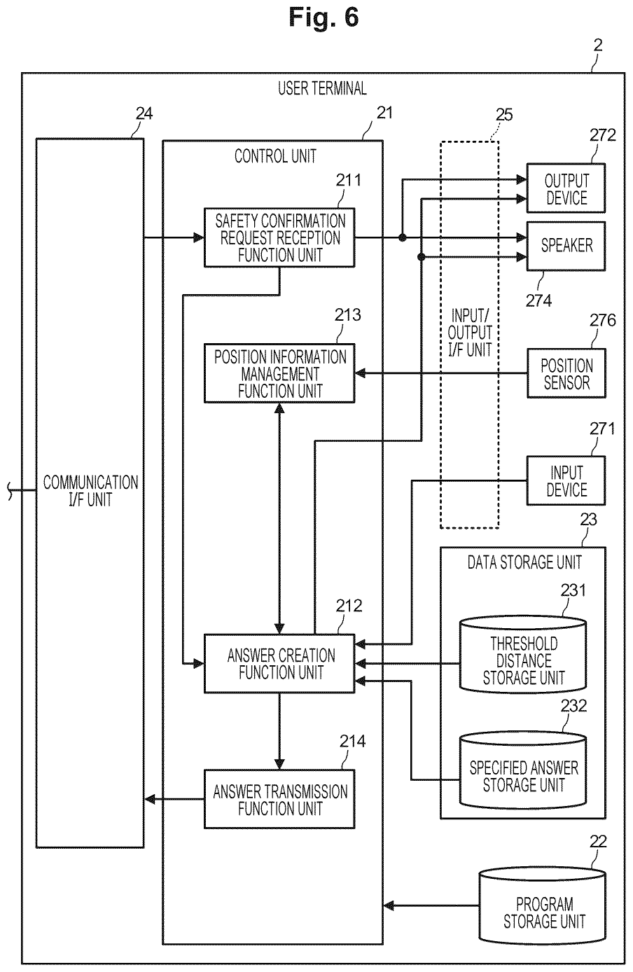

FIGS. 5 and 6 are block diagrams illustrating an example of a hardware configuration and a software configuration of the user terminal 2.

The user terminal 2 includes, for example, a smartphone carried by each user.

The user terminal 2 includes a control unit 21 using a hardware processor such as a CPU, and a storage unit including a program storage unit 22 and a data storage unit 23, a communication I/F unit 24, and an input/output I/F unit 25 are connected to the control unit 21 via a bus 26.

The communication I/F unit 24 transmits and receives information to and from the safety manager device 1 using a Communication protocol defined by the communication network NW under the control of the control unit 21. The communication I/F24 can include a wireless communication unit for wirelessly connecting to a mobile phone network (not illustrated).

An input device 271, an output device 272, a camera 273, a speaker 274, a microphone 275, a position sensor 276, and the like are connected to the input/output I/F unit 25. The output device 272 includes, for example, a display such as a liquid crystal display or an organic electro luminescence (EL) display, and displays various kinds of information to a user who is an operator of the user terminal 2. The input device 271 includes, for example, a touch panel or an operation button arranged on a display screen of the output device 272. The input device 271 is used by the user of the user terminal 2 to input an instruction necessary for the operation of the user terminal 2. The camera 273 captures an image. The speaker 274 reproduces and outputs a voice and music. The microphone 275 acquires a voice uttered by the user. The position sensor 276 includes a GPS sensor or the like that detects a current position where the user terminal 2 is present. The control unit 21 can also detect the current position on the basis of positional relationships with a plurality of base stations in a mobile phone network (not illustrated) and the like.

For example, the program storage unit 22 is configured by combining a non-volatile memory that can be written and read as needed, such as EEPROM (registered trademark) as a storage medium, and a non-volatile memory such as ROM. In addition to middleware such as an OS, the program storage unit 22 stores a program necessary for executing information processing according to the first embodiment of the present invention.

The data storage unit 23 is a storage using, as a storage medium, a combination of a nonvolatile memory to and from which write and read can be performed as needed, such as an EEPROM or a memory card, and a volatile memory such as a RAM, for example. The data storage unit 23 includes, in its storage region, a threshold distance storage unit 231 and a specified answer storage unit 232 as storage units necessary for carrying out the first embodiment.

The threshold distance storage unit 231 stores a threshold distance that is a threshold related to a preset distance. This threshold distance is used to determine whether the distance between the disaster occurrence position and the current position is short or long. The specified answer storage unit 232 stores a preset specified answer. The specified answer is, for example, information indicating a safety situation to be automatically answered, such as “sufficiently distant”. The threshold distance and the specified answer may be stored in the program storage unit 22 as a part of the information processing program in the second information processing device according to the first embodiment of the present invention. In this case, the data storage unit 23 may not include the threshold distance storage unit 231 and the specified answer storage unit 232. Alternatively, when the information processing program is activated, the threshold distance and the specified answer in the information processing program may be expanded and stored in the threshold distance storage unit 231 and the specified answer storage unit 232.

The control unit 21 includes, as processing function units according to the first embodiment of the present invention, a safety confirmation request reception function unit 211, an answer creation function unit 212, a position information management function unit 213, and an answer transmission function unit 214. Each of these processing function units 211 to 214 is achieved by causing a hardware processor of the control unit 21 to execute an information processing program in the second information processing device according to the first embodiment of the present invention stored in the program storage unit 22. At least some processing functions of at least one of the processing function units 211 to 214 may be implemented by using an integrated circuit such as ASIC, DSP, FPGA, or GPU instead of being implemented by the information processing program and the hardware processor of the control unit 21.

The safety confirmation request reception function unit 211 receives the safety confirmation request transmitted from the safety management device 1 via the communication network NW via the communication I/F unit 24, and transmits the disaster occurrence position included in the received safety confirmation request to the answer creation function unit 212.

In addition, the safety confirmation request reception function unit 211 notifies the user that the safety confirmation request has been received. Specifically, the answer creation function unit 212 displays the disaster occurrence position included in the safety confirmation request from the output device 272 via the input/output I/F unit 25, and generates a reception sound of a predetermined safety confirmation request from the speaker 274 via the input/output I/F unit 25.

The answer creation function unit 212 inquires of the position information management function unit 213 about the current position of the user terminal 2. The position information management function unit 213 acquires the current position detected by the position sensor 276 via the input/output I/F unit 25, or acquires the current position on the basis of positional relationships or the like with a plurality of base stations in the mobile phone network. Then, the answer creation function unit 212 returns the acquired current position to the answer creation function unit 212.

From the current position and the disaster occurrence position included in the safety confirmation request, the answer creation function unit 212 determines whether the disaster occurrence position is far by the threshold distance stored in the threshold distance storage unit 231 or more, that is, whether the distance between two points of the disaster occurrence position and the current position is sufficiently long.

For example, the distance d between two points can be calculated as follows. Here, the longitude and latitude of the current position is (x₁, y₁), the longitude and latitude of the disaster occurrence position is (x₂, y₂), Δx=x₂−x₁, and the radius of the earth is γ.

$$d = {γcos}^{- 1} ( sin {y}_{1} sin {y}_{2} + cos {y}_{1} cos {y}_{2} cos Δ x ) \qquad [ Math . 1 ]$$

When it is far, the answer creation function unit 212 transmits the specified safety status stored in the specified answer storage unit 232 to the answer transmission function unit 214. When it is not far, the answer creation function unit 212 notifies the user of the input request for the safety status through the output device 272 and the speaker 274 via the input/output I/E unit 25. The input request to be displayed on the output device 272 may be, for example, a request for presenting some options regarding the safety input and allowing the user to select the options. The input request may include a text box in which a detailed status can be freely described. Then, when the user inputs the safety status by the input device 271, the answer creation function unit 212 receives the safety status via the input/output I/F unit 25 and transmits the input safety status to the answer transmission function unit 214.

The answer transmission function unit 214 transmits the safety status to the safety management device 1 via the communication network NW by the communication I/F unit 14.

### (2-3) Safety Manager Terminal 3

Although not particularly illustrated, the safety manager terminal 3 can have a hardware configuration similar to that of the user terminal 2.

The safety manager terminal 3 receives the aggregated safety status transmitted from the safety management device 1 via the communication network NW by a communication I/F unit (not illustrated), and displays the safety status on an output device (not illustrated) via an input/output I/F unit (not illustrated).

### Operation Example

Next, an operation example of the device configured as described above will be described.

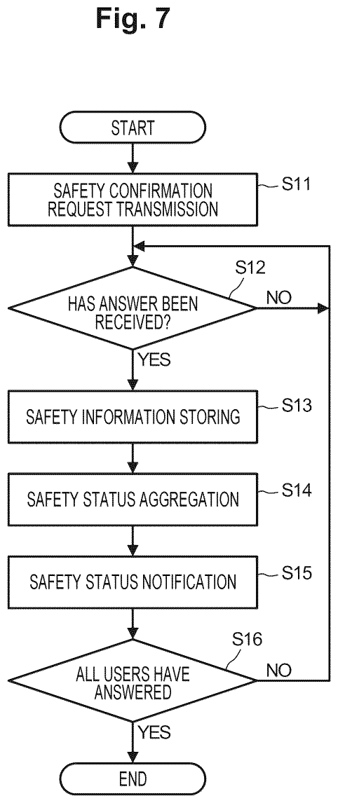

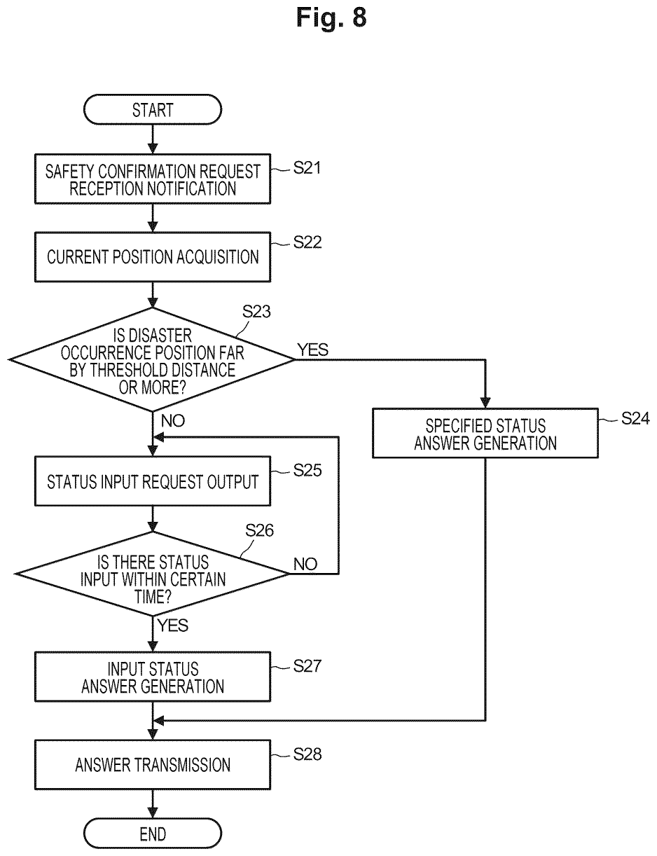

FIG. 7 is a flowchart illustrating an example of a processing procedure and processing contents of safety management processing performed by the control unit 11 of the safety management device 1. This safety management processing is processing that is started when the control unit 11 operating as the disaster information reception function unit 111 receives disaster information issued by the disaster information issuing device AR via the communication I/F unit 14. FIG. 8 is a flowchart illustrating an example of a processing procedure and processing contents of safety answer processing performed by the control unit 21 of the user terminal 2. This safety answer processing is processing started when the control unit 21 operating as the safety confirmation request reception function unit 211 receives the safety confirmation requests simultaneously transmitted by the safety management device 1 via the communication I/F unit 24.

As illustrated in FIG. 7, when the control unit 11 of the safety management device 1 operates as the disaster information reception function unit 111 to determine that the disaster information is received, the control unit operates as the safety confirmation request transmission function unit 112 to simultaneously transmit the safety confirmation request to the plurality of user terminals 2 (step S11). That is, the control unit 11 generates a safety confirmation request including a disaster occurrence position included in the received disaster information, and simultaneously transmits the generated safety confirmation request from the communication I/F unit 14 to the plurality of user terminals 2 via the communication network NW. At this time, the control unit 11 stores the safety information table 1321 storing the transmitted user ID of the user of the user terminal 2 in the safety information storage unit 132.

Thereafter, the control unit 11 operates as the answer reception function unit 113, and determines whether an answer indicating the safety status returned from any of the user terminals 2 via the communication network NW has been received via the communication I/F unit 14 (step S12). When it is determined that an answer has not been received from any of the user terminals 2, the control unit 11 repeats the processing of step S12 again. As described above, the control unit 11 waits for reception of an answer from any of the user terminals 2.

On the other hand, in each user terminal 2, when the control unit 21 operates as the safety confirmation request reception function unit 211 and determines that the safety confirmation request has been received, as illustrated in FIG. 8, the control unit 21 notifies the user that the safety confirmation request has been received by the output device 272 and the speaker 274 via the input/output I/F unit 25 (step S21).

Furthermore, the control unit 21 operates as the position information management function unit 213, and acquires the current position detected by the position sensor 276 via the input/output I/F unit 25, for example (step S22).

Then, the control unit 21 operates as the answer creation function unit 212, and determines whether the disaster occurrence position is far from the current position by the threshold distance stored in the threshold distance storage unit 231 or more from the current position and the disaster occurrence position included in the safety confirmation request (step S23).

When it is determined that the disaster occurrence position is distant from the current position by the threshold distance or more, the control unit 21 reads the specified safety status stored in the specified answer storage unit 232 and generates a specified status answer with the safety status as the specified safety status (step S24).

When it is determined in step S23 described above that the disaster occurrence position is not distant from the current position by the threshold distance or more, the control unit 21 outputs a safety status input request to the user through the output device 272 and the speaker 274 via the input/output I/F unit 25 (step S25).

Then, the control unit 21 determines whether there is a status input from the input device 271 via the input/output I/F unit 25 within a certain period of time (step S26). When it is determined that there is no status input, the control unit 21 proceeds to the processing of step S25 described above again. As described above, when there is no status input at regular time intervals, the control unit 21 outputs the status input request again. At this time, control may be added such that the volume of the notification sound in the speaker 274 is increased every time a certain period of time elapses. By repeatedly outputting the status input request in this manner, when the user is in a dangerous status in which the user cannot input the status, it is possible to raise attention to another person who may be nearby by the notification sound and improve the possibility of rescuing the user from the dangerous status.

When it is determined in step S26 that there is a status input, the control unit 21 generates an input status response in which the safety status is the input status situation (step S27).

Then, the control unit 21 operates as the answer transmission function unit 214, and transmits the specified status answer in which the safety status generated in step S24 is the specified safety status or the input status answer in which the safety status generated in step S27 is the input safety status to the safety management device 1 via the communication network NW by the communication I/F unit 14 (step S28).

Then, the control unit 21 ends the safety answer processing illustrated in the flowchart of FIG. 8 and waits for reception of the next safety confirmation request.

When the answer is transmitted from any one of the user terminals 2 in this way, the safety management device 1 receives the answer by the communication I/F unit 14, so that the control unit 11 operating as the answer reception function unit 113 can determine that the answer is received in step S12. In this case, as illustrated in FIG. 7, the control unit 11 stores the safety status indicated by the received specified status response or input status response in the record of the corresponding user in the safety information table 1321 of the safety information storage unit 132 (step S13).

Then, the control unit 11 functions as the safety status aggregation function unit 114 and aggregates the safety status from each user terminal 2 at the current time stored in the safety information table 1321 of the safety information storage unit 132 (step S14).

The control unit 11 operates as the safety status transmission function unit 115 and notifies the safety manager terminal 3 of the aggregated safety status (step S15). That is, the control unit 11 transmits the aggregated safety status from the communication I/F unit 14 to the safety manager terminal 3 via the communication network NW.

Thereafter, the control unit 11 checks the safety information table 1321 of the safety information storage unit 132 and determines whether all the users have answered (step S16). This can be determined by the control unit 11 on the basis of whether all the answer items in the safety information table 1321 are “present”. When it is determined that there is a user who has not answered yet, the control unit 11 proceeds to the processing of step S12 described above.

Then, when it is determined in step S16 that all the users have answered, the control unit 11 ends the safety management processing illustrated in the flowchart of FIG. 7 and waits for the next disaster information to be received.

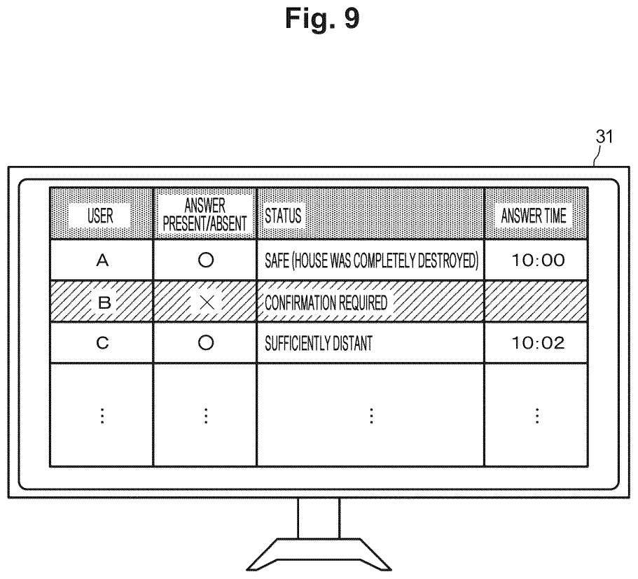

FIG. 9 is a diagram illustrating a display example of an aggregated safety status in the safety manager terminal 3 as a third information processing device in the safety confirmation system SYS. The aggregated safety status transmitted from the safety management device 1 can be displayed, for example, on a display 31 which is an output device of the safety manager terminal 3. In the safety manager terminal 3, the aggregated safety status may be processed, and unanswered users may be identified and displayed. As a result, the manager who performs the safety confirmation can easily grasp the user who needs to individually confirm the safety by separate means such as a telephone.

For example, the Great East Japan Earthquake that occurred on Mar. 11, 2011 will be described as an example. When an earthquake occurs on the Pacific coast of the Tohoku district in Japan, the disaster information issuing device AR issues disaster information. The safety management device 1 acquires an occurrence position (longitude and latitude) of the earthquake, a scale of the earthquake, and the like, and simultaneously transmits safety confirmation requests to the user terminals 2.

For example, it is assumed that an employee A has been returned to his/her parent's house in Iwate prefecture and his/her parent's house was completely destroyed. In this case, since the user terminal 2 of the employee A is close to the seismic source, the user terminal 2 requests the employee A to perform a status input, and returns an input status answer in which the safety status is the safety status input by the employee A, to the safety management device 1.

In addition, it is assumed that an employee B was working at an office in Musashino City, Tokyo, and the office was partially destroyed. In this case, since the user terminal 2 of the employee B is close to the seismic source, the status input request is continuously output to the employee B.

On the other hand, it is assumed that an employee C was working at home from his home in Kyoto, but there was no influence. In this case, since the user terminal 2 of the employee C is far from the seismic source, the employee C does not perform the status input and a specified status answer in which the safety status is a specified safety status indicating that the user is far from the seismic source is returned to the safety management device 1.

Then, the safety management device 1 aggregates the safety status in the answers returned from each of the user terminals 2, and transmits the aggregated safety status to the safety manager terminal 3 of a safety manager X who is the safety management manager of the employees.

The safety manager terminal 3 of the safety manager X displays the aggregated safety status as illustrated in FIG. 9. As a result, the safety manager X can grasp that the employee A replies at 10:00 that the house has been completely destroyed but the status is safe, or the employee C replies at 10:02 that the employee C is sufficiently distant, but there is no reply from the employee B and it is in the confirmation required situation. Therefore, the safety manager X can perform the safety confirmation of the employee B by another means such as calling the user terminal 2 which is a smartphone carried by the employee B.

Although not particularly illustrated, the safety status confirmed by the safety manager by another means may be transmitted from the safety manager terminal 3 via the communication network NW. In this case, the control unit 11 of the safety management device 1 may handle the safety status from the safety manager terminal 3 as one of the answers in step S12.

### (Actions and Effects)

As described above, in the user terminal 2 which is the second information processing device according to the first embodiment, when the safety confirmation request reception function unit 211 receives the safety confirmation request including the disaster occurrence position from the safety management device 1 via the communication network NW, the output device 272 and the speaker 274 notify that the safety confirmation request has been received. As described above, the safety confirmation request reception function unit 211, the output device 272, and the speaker 274 are examples of the notification unit. Then, the answer creation function unit 212 determines whether the disaster occurrence position included in the safety confirmation request is distant from the current position acquired by the position information management function unit 213, which is an example of the position detection unit that detects the current position of the user terminal 2 from the position sensor 276 or the like, by a threshold distance or more. When the disaster occurrence position is distant from the current position, the answer transmission function unit 214 returns a specified status answer, which is a specified safety status indicating that it is safe because the disaster occurrence position is sufficiently distant from the disaster occurrence position, to the safety management device 1, for example. As described above, the answer creation function unit 212 and the answer transmission function unit 214 are examples of the safety answer unit.

As described above, when the safety confirmation request is issued, the second information processing device according to the first embodiment that has received the safety confirmation request obtains the distance between the second information processing device and the disaster occurrence point, and when the distance between the two points is longer than or equal to the threshold distance, the second information processing device automatically replies that the second information processing device is sufficiently distant from the disaster occurrence point. Therefore, the manager who performs the safety confirmation does not need to confirm the safety of the user sufficiently distant from the disaster occurrence point, and further, the user sufficiently distant from the disaster occurrence point does not need to reply to the safety confirmation request, and the prompt safety confirmation of all users in which the operation of both the user and the administrator is reduced is achieved. That is, according to the second information processing device according to the first embodiment, it is possible to achieve both convenience of the user and comprehensive and prompt safety confirmation.

In the user terminal 2 as the second information processing device according to the first embodiment, when the disaster occurrence position is closer than the threshold distance from the current position, the answer creation function unit 212 causes the output device 272 and the speaker 274 to notify the user of the input request for the safety status, and returns the input status answer, which is the safety status input by the input device 271, which is an example of the input unit that receives the input of the safety status, to the safety management device 1 by the answer transmission function unit 214.

Therefore, in the second information processing device according to the first embodiment, when the distance between the second information processing device and the disaster occurrence point is shorter than the threshold distance, the user is caused to input his/her safety status, and thus, it is possible to prevent missing of the safety confirmation of the user whose safety confirmation is actually needed.

### Second Embodiment

In the first embodiment described above, the threshold distance has a fixed value. In the second embodiment of the present invention, the threshold distance is variable.

### Configuration Example

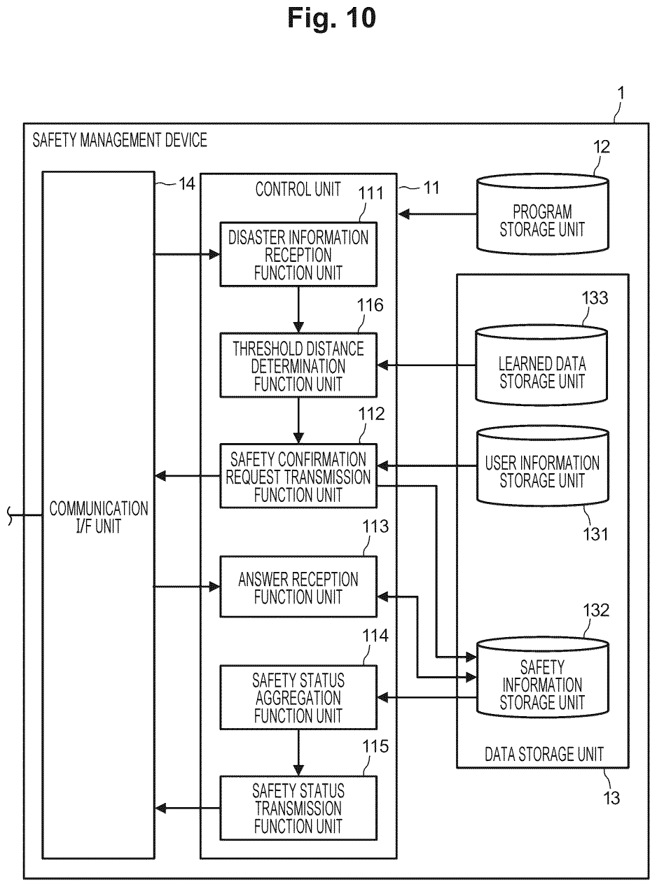

FIG. 10 is a block diagram illustrating an example of a software configuration of a safety management device 1 as a first information processing device according to a second embodiment of the present invention. In the second embodiment, in the safety management device 1, in addition to the configuration of the first embodiment, the control unit 11 includes a threshold distance determination function unit 116, and the data storage unit 13 includes a learned data storage unit 133.

The learned data storage unit 133 stores learned data obtained by learning a threshold distance with respect to a disaster occurrence position and a disaster scale from data indicating the distance for avoiding a damage with respect to disaster occurrence positions and disaster scales of a large number of disasters in the past. The threshold distance determination function unit 116 uses the learned data to determine a threshold distance for the disaster occurrence position and the disaster scale included in the disaster information received by the disaster information reception function unit 111. The threshold distance determination function unit 116 transmits the determined threshold distance to the safety confirmation request transmission function unit 112, and includes the threshold distance in the safety confirmation requests to be simultaneously transmitted to the user terminals 2.

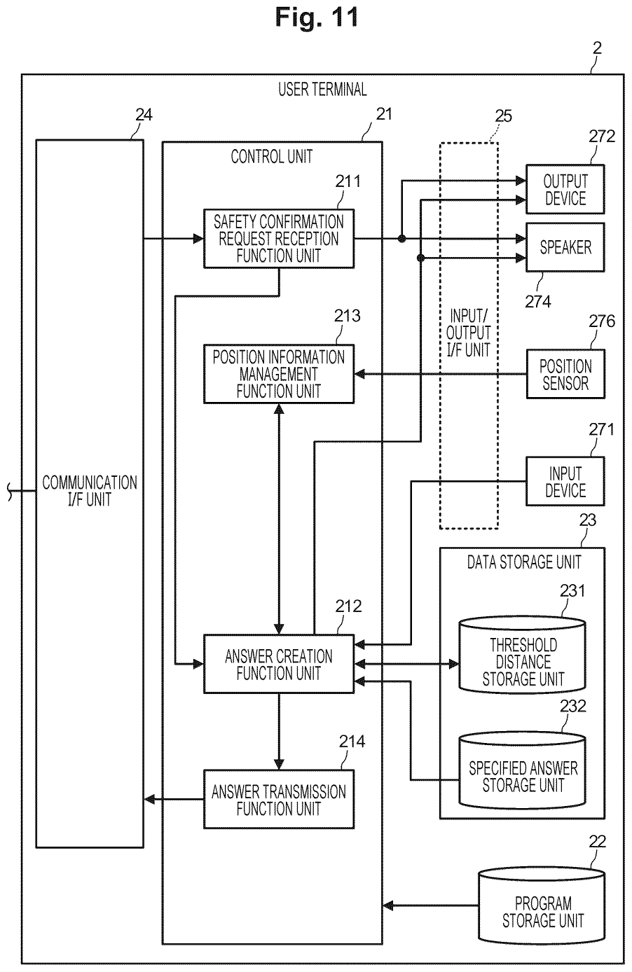

FIG. 11 is a block diagram illustrating an example of a software configuration of the user terminal 2 as a second information processing device according to the second embodiment of the present invention. In the second embodiment, the answer creation function unit 212 of the control unit 21 stores the threshold distance included in the safety confirmation request received by the safety confirmation request reception function unit 211 in the threshold distance storage unit 231.

### Operation Example

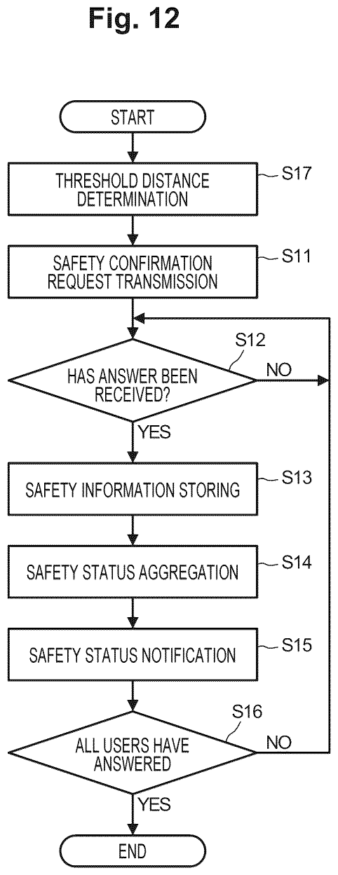

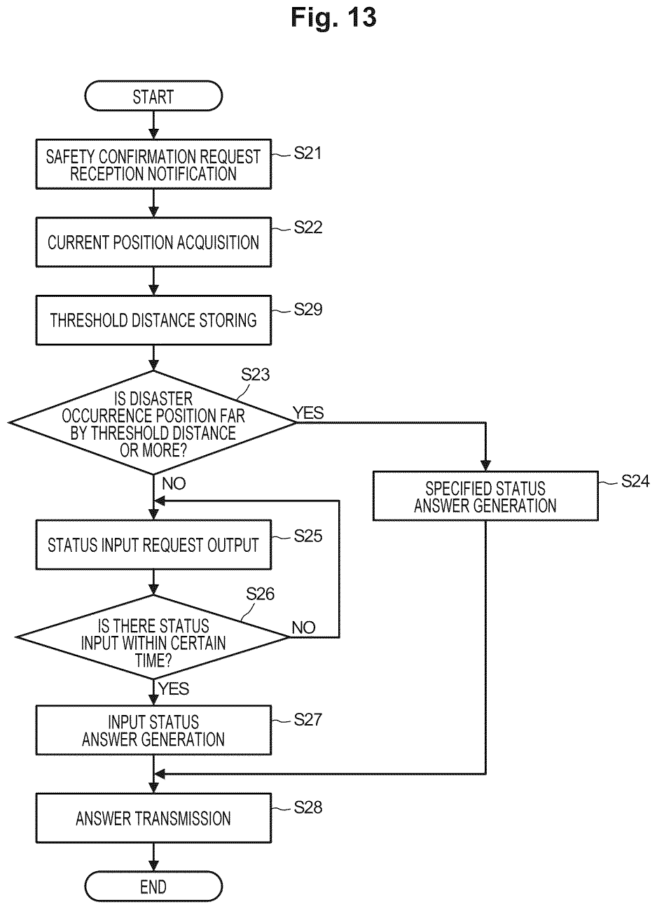

FIG. 12 is a flowchart illustrating an example of a processing procedure and processing contents of safety management processing performed by a control unit of the safety management device in the second embodiment of the present invention. FIG. 13 is a flowchart illustrating an example of a processing procedure and processing contents of safety answer processing performed by the control unit of the user terminal 2 as the second information processing device according to the second embodiment of the present invention.

As illustrated in FIG. 12, when the control unit 11 of the safety management device 1 operates as the disaster information reception function unit 111 and determines that the disaster information is received, the control unit 11 operates as the threshold distance determination function unit 116 and determines the threshold distance on the basis of the disaster occurrence position and the disaster scale included in the disaster information received by the disaster information reception function unit 111 (step S17).

Thereafter, the control unit 11 proceeds to the processing of step S11 described above, operates as the safety confirmation request transmission function unit 112, and simultaneously transmits the safety confirmation requests to the plurality of user terminals 2 (step S11), However, in the present embodiment, the safety confirmation request transmitted simultaneously includes a threshold distance in addition to the disaster occurrence position and the threshold distance. The subsequent processing is similar to that in the first embodiment.

As illustrated in FIG. 13, after acquiring the current position in step S22, the control unit 21 of the user terminal 2 that has received such a safety confirmation request operates as the answer creation function unit 212 and stores the threshold distance included in the safety confirmation request in the threshold distance storage unit 231 (step S29). Then, the processing proceeds to step S23. As a result, the user terminal 2 can use the threshold distance determined by the safety management device 1 on the basis of the disaster occurrence position and the disaster scale. The subsequent processing is similar to that in the first embodiment.

### (Actions and Effects)

As described above, in the safety management device 1 that is the first information processing device according to the second embodiment, when the disaster information including the disaster occurrence position and the disaster scale is received via the communication network NW, the threshold distance determination function unit 116 which is an example of the threshold determination unit determines the threshold distance on the basis of the disaster occurrence position and the disaster scale. Then, the safety confirmation request transmission function unit 112, which is an example of the safety confirmation requesting unit, simultaneously transmits a safety confirmation request including a disaster occurrence position and a threshold distance to a plurality of user terminals, which are the second information processing devices according to the second embodiment, via the communication network NW.

Therefore, an appropriate threshold distance can be determined according to the disaster that has occurred, and the user terminal 2 can determine whether to automatically answer using the appropriately set threshold distance. The user terminal 2 that is the second information processing device according to the second embodiment also has the same operation and effect as those of the first embodiment.

Further, in the second information processing device according to the second embodiment, the safety confirmation requests simultaneously transmitted from the safety management device 1 further include a threshold distance, and the answer creation function unit 212 as the safety answer unit can determine whether the disaster occurrence position is distant from the current position by the threshold distance or more by using the threshold distance included in the safety confirmation request.

Therefore, it is possible to determine whether to perform automatically answer using a threshold distance appropriately set according to the disaster that has occurred.

### Third Embodiment

In the first embodiment described above, it is determined whether the safety status has been input in each user terminal 2 within a certain period of time, and when the safety status has not been input within the certain period of time, the status input request is output again. In the third embodiment of the present invention, this determination is made on the safety management device 1 side.

### Configuration Example

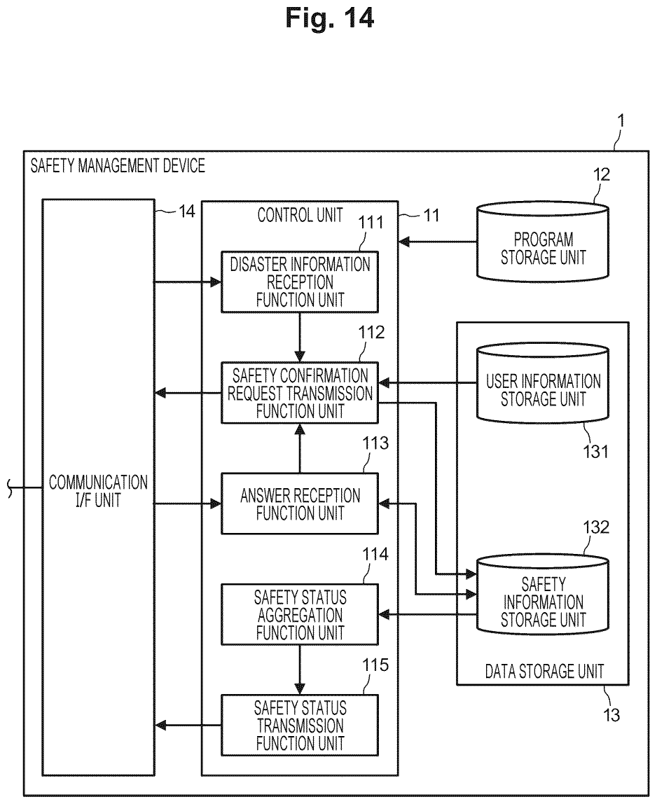

FIG. 14 is a block diagram illustrating an example of a software configuration of the safety management device 1 as a first information processing device according to a third embodiment of the present invention. In the third embodiment, the safety management device 1 is configured to request the safety confirmation request transmission function unit 112 to retransmit the safety confirmation request from the answer reception function unit 113 in the configuration of the first embodiment.

The answer reception function unit 113 checks the safety information table 1321 stored in the safety information storage unit 132 at regular intervals to extract a user who has not transmitted an answer, and requests the safety confirmation request transmission function unit 112 to retransmit the safety confirmation request to the user terminal 2 of the user. Upon receiving this request, the safety confirmation request transmission function unit 112 retransmits the safety confirmation request to the designated user terminal 2.

### Operation Example

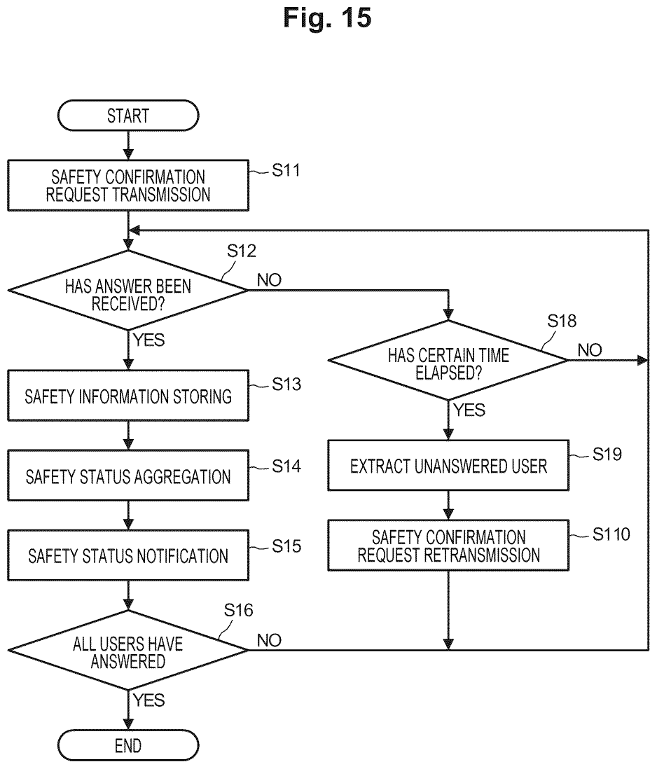

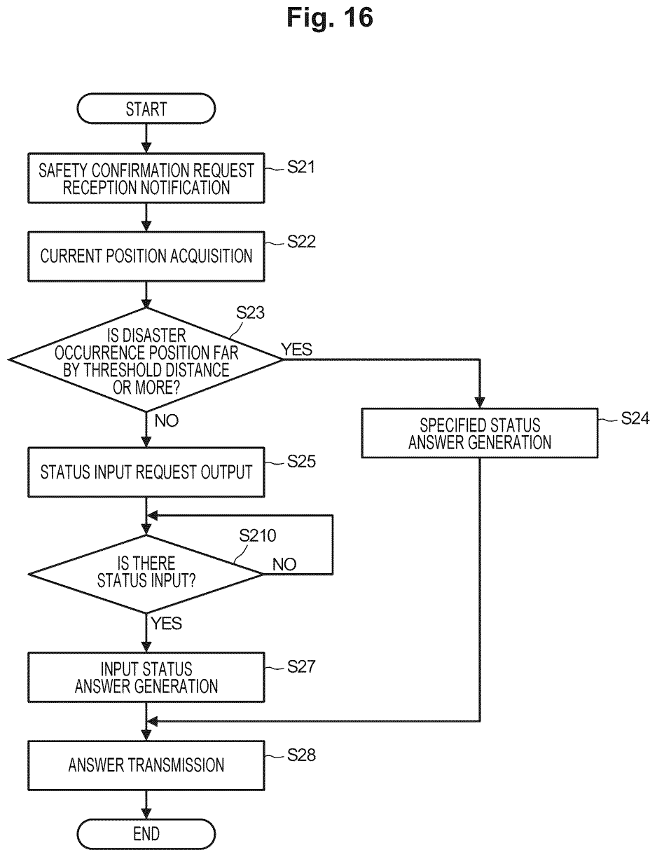

FIG. 15 is a flowchart illustrating an example of a processing procedure and processing contents of safety management processing performed by a control unit of the safety management device in the third embodiment of the present invention. FIG. 16 is a flowchart illustrating an example of a processing procedure and processing contents of safety answer processing performed by a control unit of the user terminal 2 as a second information processing device according to the third embodiment of the present invention.

As illustrated in FIG. 15, when the control unit 11 operating as the answer reception function unit 113 of the safety management device 1 determines in step S12 that an answer has not been received from any user terminal 2, the control unit determines whether a certain period of time has elapsed (step S18), When it is determined that the certain time has not elapsed yet, the control unit 11 proceeds to the processing of step S12 described above.

On the other hand, when determining that the certain period of time has elapsed, the control unit 11 extracts the user whose answer item is “absent” in the safety information table 1321 stored in the safety information storage unit 132 (step S19).

Then, the control unit 11 operates as the safety confirmation request transmission function unit 112, and retransmits the safety confirmation request to the extracted user terminal 2 of the user via the communication network NW by the communication I/F unit 14 (step S110). Thereafter, the control unit 11 proceeds to the processing of step S12 described above. The other processing is similar to that in the first embodiment.

On the other hand, as illustrated in FIG. 16, the control unit 21 of the user terminal 2 outputs the input request of the safety status to the user by the output device 272 and the speaker 274 in step S25, and then, determines whether there is a status input from the input device 271 via the input/output I/F unit 25 (step S210). When it is determined that there is no status input, the control unit 21 repeats the processing of step S210. That is, the control unit 21 waits for a status input from the input device 271.

When a certain period of time has elapsed while waiting for the status input, a safety confirmation request is transmitted again from the safety management device 1. As a result, the control unit 21 cancels the waiting for the status input in step S210 and starts the processing in step S21 again, That is, the control unit 21 uses the output device 272 and the speaker 274 to notify the user that the safety confirmation request has been received. The other processing is similar to that in the first embodiment.

In general, the sound volume of the safety confirmation request reception notification according to the issuing of the disaster information is set to be larger than the sound volume of the status input request. Therefore, it is unnecessary to perform sound volume control such as increasing the sound volume of the notification sound in the speaker 274 every time a certain period of time elapses as in the first embodiment.

### (Actions and Effects)

As described above, in the safety management device 1 that is the first information processing device according to the third embodiment, the answer reception function unit 113 extracts the user terminal 2 that has not returned an answer to the safety confirmation request at regular time intervals, and the safety confirmation request transmission function unit 112 retransmits the safety confirmation request to the extracted user terminals 2 via the communication network NW.

Therefore, it is possible to prompt the user who has not answered to answer, and it is possible to increase the probability of being rescued for the user who cannot answer.

In the user terminal 2 serving as the second information processing device according to the third embodiment can have the same actions and effects as those of the first embodiment without determining the elapse of a certain period of time.

In the safety management device 1 that is the first information processing device according to the third embodiment, it is needless to say that the threshold distance may be determined according to the disaster that has occurred as in the second embodiment, and the threshold distance may be used in each user terminal 2 that is the second information processing device according to the third embodiment.

### OTHER EMBODIMENTS

The present invention is not limited to the above-described embodiments.

For example, the safety manager terminal 3 may be shared by the safety management device 1. In this case, the safety management device 1 may be configured such that the safety status transmission function unit 115 does not transmit the aggregated safety status by the communication I/F unit 14 but causes the output device 172 to display the safety status via the input/output I/F unit 15.

The answer returned from the user terminal 2 to the safety management device 1 may include the current position itself of the user terminal 2 or the area of the current position.

In addition, the flow of each kind of processing described above is not limited to the described procedure. For example, the order of the processing in step S22 and the processing in step S29 in FIG. 13 may be reversed, or the processing may be performed in parallel at the same time. In this manner, the order of some steps may be changed, or some steps may be performed in parallel at the same time. Furthermore, the processing contents of some steps may be modified.

In addition, the method described in the information processing program according to each embodiment can be stored as a processing program (software means) that can be executed by a computing machine (computer) in a recording medium such as a magnetic disk (Floppy (registered trademark) disk, hard disk, or the like), an optical disc (CD-ROM, DVD, MO, or the like), or a semiconductor memory (ROM, RAM, flash memory, or the like) or can be distributed by being transmitted through a communication medium. Note that the program stored on the medium side also includes a setting program for configuring, in the computing machine, the software means (including not only an execution program but also a table and a data structure) to be executed by the computing machine. The computing machine that implements the present device executes the above-described processing by reading the program recorded in the recording medium, constructing the software means by the setting program as needed, and controlling the operation by the software means. Note that the recording medium described in the present specification is not limited to a recording medium for distribution, but includes a storage medium such as a magnetic disk or a semiconductor memory provided in the computer or in a device connected via a communication network NW.

The present invention is not limited to the embodiment as it is but can be embodied by modifying components in the practical phase without departing from the gist thereof. In addition, various inventions can be formed by appropriately combining a plurality of the constituent elements disclosed in the above embodiments. For example, some constituent elements may be deleted from all the constituent elements described in the embodiments. Furthermore, components in different embodiments may be appropriately combined.

### REFERENCE SIGNS LIST

1 Safety management device
2 User terminal
3 Safety manager terminal
11, 21 Control unit
12, 22 Program storage unit
13, 23 Data storage unit
14, 24 Communication I/F unit
15, 25 Input/output I/F unit
16, 26 Bus
31 Display
111 Disaster information reception function unit
112 Safety confirmation request transmission function unit
113 Answer reception function unit
114 Safety status aggregation function unit
115 Safety status transmission function unit
116 Threshold distance determination function unit
131 User information storage unit
132 Safety information storage unit
1321 Safety information table
133 Data storage unit
171, 271 Input device
172, 272 Output device
211 Safety confirmation request reception function unit
212 Answer creation function unit
213 Position information management function unit
214 Answer transmission function unit
231 Threshold distance storage unit
232 Specified answer storage unit
273 Camera
274 Speaker
275 Microphone
276 Position sensor
NW Communication network
SYS Safety confirmation system

1. An information processing device comprising:
position detection circuitry that detects a current position;
notification circuitry that, when receiving a safety confirmation request including a disaster occurrence position via a communication network, notifies that the safety confirmation request has been received; and
safety answer circuitry that, when the disaster occurrence position included in the safety confirmation request is far from the current position by a threshold distance or more, returns a specified safety status.

2. The information processing device according to claim 1, further comprising:
input circuitry that receives an input of a safety status,
wherein, when the disaster occurrence position is closer to the current position than a threshold distance, the safety answer circuitry causes the notification circuitry to notify an input request for the safety status, and
returns the safety status input by the input circuitry.

3. The information processing device according to claim 2, wherein:
the safety confirmation request further includes the threshold distance, and
the safety answer circuitry determines whether the disaster occurrence position is far from the current position by the threshold distance or more by using the threshold distance included in the safety confirmation request.

4. An information processing device comprising:
threshold determination circuitry that, when disaster information including a disaster occurrence position and a disaster scale is received via a communication network, determines a threshold distance based on the disaster occurrence position and the disaster scale;
safety confirmation requesting circuitry that simultaneously transmits a safety confirmation request including the disaster occurrence position and the threshold distance to a plurality of user terminals via the communication network; and
safety status transmission circuitry that aggregates the safety status returned from each of the plurality of user terminals via the communication network, and outputs the safety status that has been aggregated.

5. A safety confirmation system in which a first information processing device and a plurality of second information processing devices used by a plurality of users can communicate with each other via a communication network,
wherein:
the first information processing device includes safety confirmation requesting circuitry that, when receiving disaster information including a disaster occurrence position and a disaster scale via the communication network, simultaneously transmits a safety confirmation request including the disaster occurrence position to the plurality of second information processing devices via the communication network,
the second information processing device includes:
position detection circuitry that detects a current position;
input circuitry that receives an input of a safety status;
notification circuitry that, when receiving the safety confirmation request via the communication network, notifies that the safety confirmation request has been received; and
safety answer circuitry that returns a specified safety status when the disaster occurrence position included in the safety confirmation request is far from the current position by a threshold distance or more, and causes the notification circuitry to notify an input request of the safety status when the disaster occurrence position is closer to the current position than the threshold distance, and returns the safety status input by the input circuitry, and
the first information processing device further includes a safety status output circuitry that aggregates the safety status returned from each of the plurality of second information processing devices via the communication network and outputs the safety status that has been aggregated.

6-8. (canceled)
